(19) United States
(12) Patent Application Publication
(10) Pub. No.: US 2025/0261110 A1
(43) Pub. Date: Aug. 14, 2025

(54) TECHNIQUES FOR CONFIGURING UPLINK WAKEUP SIGNAL AND RANDOM ACCESS TO ENABLE NETWORK ENERGY SAVINGS

(71) Applicant: QUALCOMM Incorporated, San Diego, CA (US)

(72) Inventors: Navid ABEDINI, Basking Ridge, NJ (US); Naeem AKL, Bridgewater, NJ (US)

(21) Appl. No.: 18/441,313

(22) Filed: Feb. 14, 2024

(51) Int. Cl. H04W 52/02; H04W 74/0833

(52) U.S. Cl. CPC H04W 52/0229; H04W 74/0833

(57) ABSTRACT

Various aspects of the present disclosure generally relate to wireless communication. In some aspects, a user equipment (UE) may receive an uplink wakeup signal (UL-WUS) configuration and a random access channel (RACH) configuration for a network energy savings (NES) cell, wherein the NES cell is associated with an on-demand system information block 1 (SIB1). The UE may transmit, to the NES cell, an UL-WUS in an UL-WUS occasion associated with the UL-WUS configuration, wherein the UL-WUS includes one or more of a request for the on-demand SIB1 or a request to start a RACH procedure. Numerous other aspects are described.

### FIELD OF THE DISCLOSURE

Aspects of the present disclosure generally relate to wireless communication and specifically relate to techniques, apparatuses, and methods associated with configuring an uplink wakeup signal (UL-WUS) and random access to enable network energy savings (NES).

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving an uplink wakeup signal (UL-WUS) configuration and a random access channel (RACH) configuration for a network energy savings (NES) cell, wherein the NES cell is associated with an on-demand system information block 1 (SIB1). The method may include transmitting, to the NES cell, an UL-WUS in an UL-WUS occasion associated with the UL-WUS configuration, wherein the UL-WUS includes one or more of a request for the on-demand SIB1 or a request to start a RACH procedure.

Some aspects described herein relate to a UE for wireless communication. The UE may include one or more memories and one or more processors coupled to the one or more memories. The one or more processors may be configured to receive an UL-WUS configuration and a RACH configuration for an NES cell, wherein the NES cell is associated with an on-demand SIB1. The one or more processors may be configured to transmit, to the NES cell, an UL-WUS in an UL-WUS occasion associated with the UL-WUS configuration, wherein the UL-WUS includes one or more of a request for the on-demand SIB1 or a request to start a RACH procedure.

Some aspects described herein relate to an apparatus for wireless communication. The apparatus may include means for receiving an UL-WUS configuration and a RACH configuration for an NES cell, wherein the NES cell is associated with an on-demand SIB1. The apparatus may include means for transmitting, to the NES cell, an UL-WUS in an UL-WUS occasion associated with the UL-WUS configuration, wherein the UL-WUS includes one or more of a request for the on-demand SIB1 or a request to start a RACH procedure.

Some aspects described herein relate to a non-transitory computer-readable medium that stores a set of instructions for wireless communication by a UE. The set of instructions, when executed by one or more processors of the UE, may cause the UE to receive an UL-WUS configuration and a RACH configuration for an NES cell, wherein the NES cell is associated with an on-demand SIB1. The set of instructions, when executed by one or more processors of the UE, may cause the UE to transmit, to the NES cell, an UL-WUS in an UL-WUS occasion associated with the UL-WUS configuration, wherein the UL-WUS includes one or more of a request for the on-demand SIB1 or a request to start a RACH procedure.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of a four-step random access procedure, in accordance with the present disclosure.

FIG. 5 is a diagram illustrating an example of a two-step random access procedure, in accordance with the present disclosure.

FIG. 6 is a diagram illustrating an example associated with separate uplink wakeup signal (UL-WUS) and random access configurations and occasions to enable network energy savings (NES), in accordance with the present disclosure.

FIG. 7 is a diagram illustrating an example associated with shared UL-WUS and random access configurations and occasions to enable NES, in accordance with the present disclosure.

FIG. 8 is a flowchart illustrating an example process performed, for example, by a UE in accordance with the present disclosure.

FIG. 9 is a diagram of an example apparatus for wireless communication in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Network energy savings (NES) and/or network energy efficiency measures are expected to have increased importance in wireless network operations for various reasons, such as climate change mitigation, environmental sustainability, and/or network cost reduction, among other examples. For example, although 5G New Radio (NR) generally offers a significant energy efficiency improvement per gigabyte over previous generations (e.g., long term evolution (LTE)), some NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth of the total cost to operate a wireless network, and over 90% of network operating costs are spent on energy (e.g., fuel and electricity). The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are factors that may drive adoption and/or expansion of wireless networks.

One technique to increase energy efficiency in a RAN is to enable “on-demand” broadcast transmissions by a network node and/or a cell. For example, to reduce power consumption at a network node, the network node may transmit certain broadcast communications (e.g., system information communications, synchronization signal blocks (SSBs), and/or system information blocks (SIBs)) in an on-demand manner (e.g., upon request, rather than on a periodic basis or following a periodic schedule). In some examples, an on-demand communication may be a communication that carries remaining minimum system information (RMSI), such as a SIB type 1 (SIB1) or another SIB (e.g., as defined, or otherwise fixed, by a wireless communication standard, such as the 3GPP). In some examples, an SSB and/or SIB1 may be transmitted via a cell to support initial access, measurement, camping, and/or cell selection or reselection by a user equipment (UE). Typically, such communications are periodically broadcasted via the cell (e.g., following a periodic schedule where the communication(s) are transmitted one or more times, and often beamswept in multiple beam directions, in each period) so that idle and/or inactive UEs and/or UEs moving into a geographic region of a cell can receive the communications and establish a connection via the cell. Therefore, one way to reduce network power consumption is to reduce transmissions of such communications such that, for example, an SSB and/or SIB1 is transmitted less frequently by a cell operating in an NES mode (or NES state).

For example, a cell may operate in an NES mode or an NES state associated with an on-demand SIB1, where the SIB1 is transmitted only upon request by a UE, in order to reduce overhead and/or reduce power consumption. For example, a cell may operate in an NES mode or an NES state associated with an on-demand SIB1 during periods with low activity (e.g., there are not many UEs entering and exiting the coverage of the cell, or there are not many UEs that are attempting to establish a connection), in which case periodically broadcasting SIB1 (e.g., every 20 or 160 milliseconds) may be wasteful. In such cases, the cell may broadcast SIB1 only on-demand, or only upon request by a UE, where the request may be carried in an uplink wakeup signal (UL-WUS). For example, a UE in an idle or inactive mode or a UE that has detected or selected the cell operating in accordance with the on-demand SIB1 configuration may transmit an UL-WUS to the cell to request and acquire SIB1 (e.g., in order to camp on the cell, connect to the cell, or prepare to connect to the cell). In particular, the UE may generally transmit the UL-WUS in an occasion when the cell is monitoring for the UL-WUS, such that the cell may transition to a more active state and transmit the on-demand SIB1 upon detecting the UL-WUS in a monitoring occasion.

Various aspects described herein generally relate to techniques for configuring an UL-WUS and random access to enable NES. For example, as described herein, the UL-WUS may be associated with various parameters that may be the same as or similar to an initial message associated with a random access channel (RACH) procedure, such as msg1 of a four-step RACH procedure or a msgA preamble of a two-step RACH procedure. For example, a msg1 or a msgA preamble is typically the first message that a UE transmits to a cell in order to identify the UE and start a RACH procedure to establish a connection to the cell. Accordingly, some aspects described herein relate to techniques for indicating UL-WUS and RACH configurations and occasions. For example, in some aspects, an NES cell associated with an on-demand SIB1 configuration may support separate configurations and occasions for an UL-WUS and an initial message used to start a RACH procedure (e.g., a msg1 or a msgA preamble). In this way, the NES cell may also support on-demand RACH monitoring, where the NES cell monitors a RACH occasion only in cases where a UE transmits an UL-WUS that includes a request to start a RACH procedure. Furthermore, in some aspects, the UL-WUS may be associated with different formats or identifiers, which may be used to indicate whether the UE is only requesting SIB1 (e.g., such that the NES cell does not need to monitor upcoming RACH occasions), only starting a RACH procedure (e.g., such that the NES cell does not need to transmit SIB1), or requesting SIB1 and starting a RACH procedure. Additionally, or alternatively, the NES cell may support shared UL-WUS and RACH configurations and occasions (e.g., where the UL-WUS shares many parameters and shares occasions with msg1 or a msgA preamble). In such cases, an anchor cell may provide a UE with parameters for selecting or reselecting the NES cell, and the on-demand SIB1 may provide only a delta between the parameters indicated by the anchor cell and the minimum system information needed to establish a connection to the NES cell. Furthermore, some aspects described herein relate to techniques to configure retransmissions and transmit power parameters for a msg1 or a msgA preamble independently from or in accordance with a number of retransmissions and transmit power parameters used for the UL-WUS.

Multiple-access radio access technologies (RATs) have been adopted in various telecommunication standards to provide common protocols that enable wireless communication devices to communicate on a municipal, enterprise, national, regional, or global level. For example, 5G NR is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

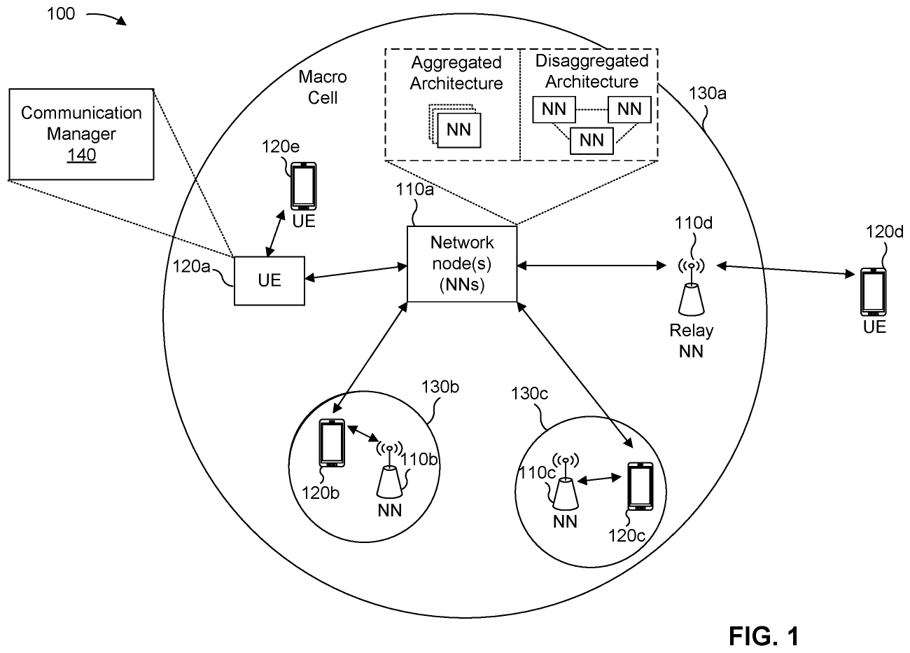

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a RAN.

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive an UL-WUS configuration and a RACH configuration for an NES cell, wherein the NES cell is associated with an on-demand SIB1; and transmit, to the NES cell, an UL-WUS in an UL-WUS occasion associated with the UL-WUS configuration, wherein the UL-WUS includes one or more of a request for the on-demand SIB1 or a request to start a RACH procedure. Additionally, or alternatively, the communication manager 140 may perform one or more other operations described herein.

As indicated above, FIG. 1 is provided as an example. Other examples may differ from what is described with regard to FIG. 1.

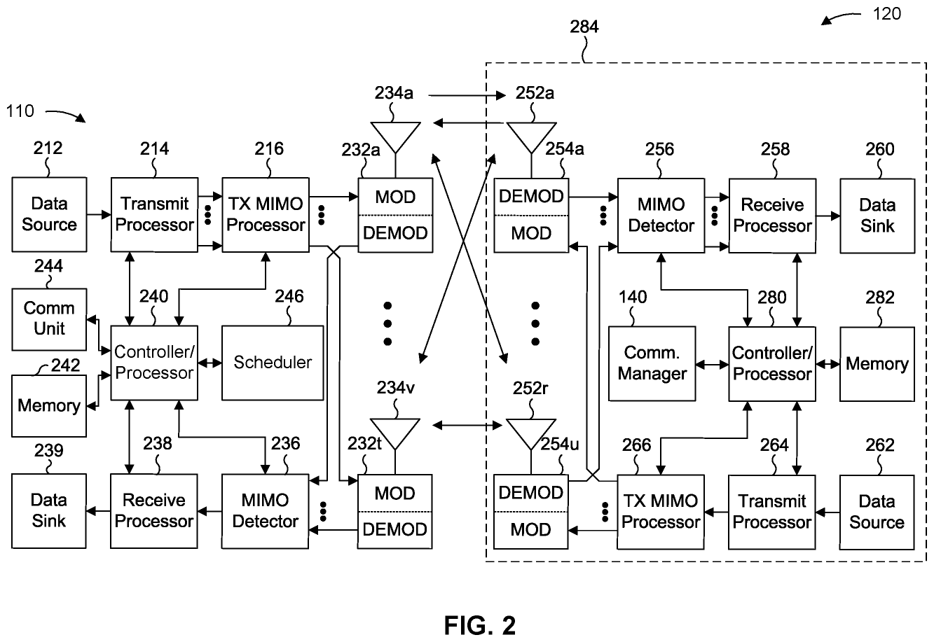

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes May be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

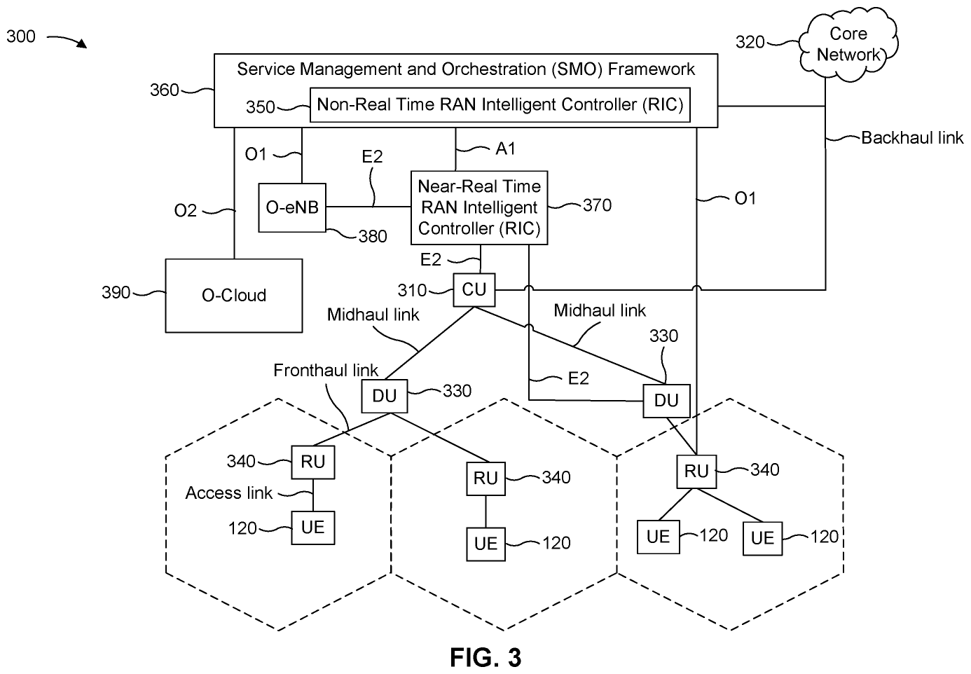

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

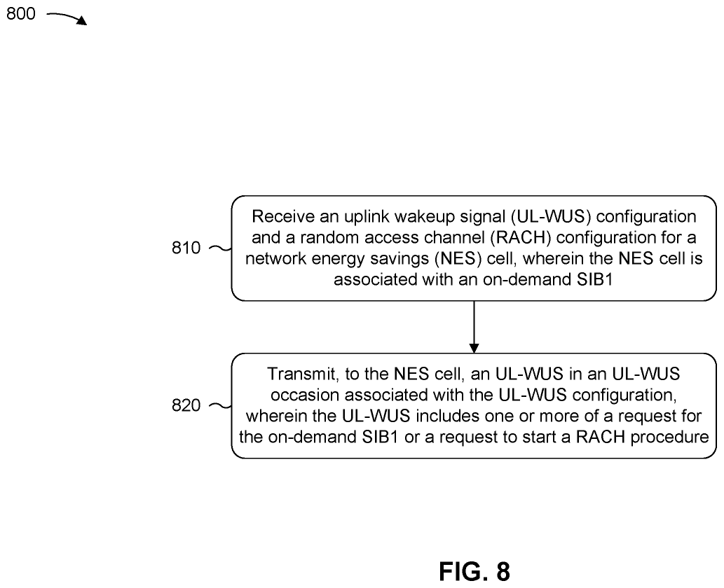

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with configuring an UL-WUS and random access to enable NES, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 800 of FIG. 8 or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8 or other processes as described herein. In some examples, executing instructions may include running the instructions, converting the instructions, compiling the instructions, and/or interpreting the instructions, among other examples.

In some aspects, the UE 120 includes means for receiving an UL-WUS configuration and a RACH configuration for an NES cell, wherein the NES cell is associated with an on-demand SIB1; and/or means for transmitting, to the NES cell, an UL-WUS in an UL-WUS occasion associated with the UL-WUS configuration, wherein the UL-WUS includes one or more of a request for the on-demand SIB1 or a request to start a RACH procedure. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

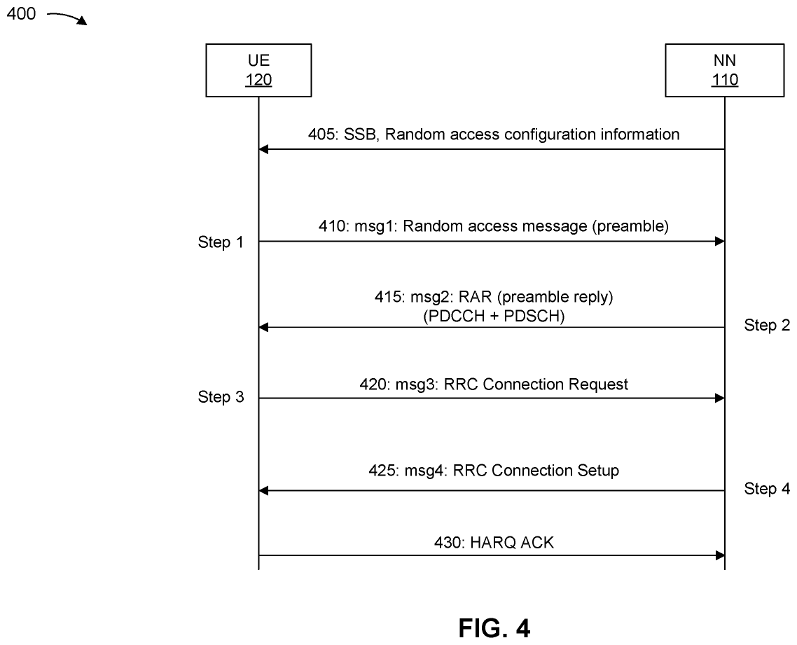

FIG. 4 is a diagram illustrating an example 400 of a four-step random access procedure, in accordance with the present disclosure. As shown in FIG. 4, a network node 110 and a UE 120 may communicate with one another to perform the four-step random access procedure, which may be referred to as a four-step RACH procedure.

As shown by reference number 405, the network node 110 may transmit, and the UE 120 may receive, one or more SSBs and random access configuration information. In some aspects, the random access configuration information may be transmitted in and/or indicated by an SSB and/or system information (e.g., in one or more SIBs, such as SIB1), such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 410, the UE 120 may transmit a RAM, which may include a preamble (sometimes referred to as a random access preamble, a physical RACH (PRACH) preamble, or a RAM preamble). The message that includes the preamble may be referred to as a message 1, msg1, MSG1, a first message, or an initial message in a four-step random access procedure. The random access message may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgement (ACK).

As indicated above, FIG. 4 is provided as an example. Other examples may differ from what is described with regard to FIG. 4.

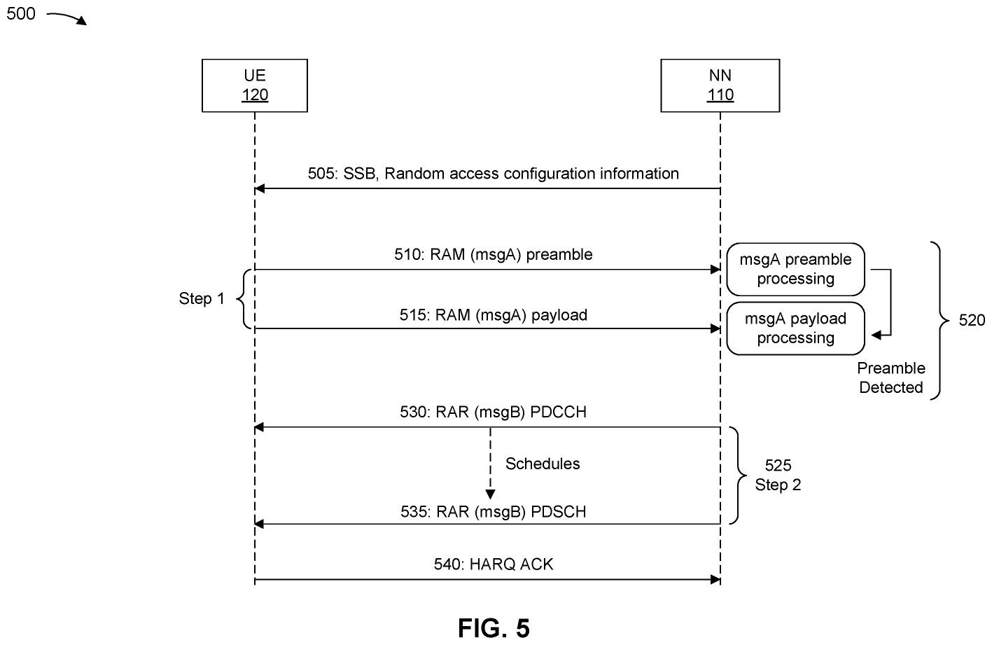

FIG. 5 is a diagram illustrating an example 500 of a two-step random access procedure, in accordance with the present disclosure. As shown in FIG. 5, a network node 110 and a UE 120 may communicate with one another to perform the two-step random access procedure, which may be referred to as a two-step RACH procedure.

As shown by reference number 505, the network node 110 may transmit, and the UE 120 may receive, one or more SSBs and random access configuration information. In some aspects, the random access configuration information may be transmitted in and/or indicated by an SSB and/or system information (e.g., in one or more SIBs, such as SIB1), such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a RAM and/or receiving a RAR to the RAM.

As shown by reference number 510, the UE 120 may transmit, and the network node 110 may receive, a RAM preamble. As shown by reference number 515, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure. For example, the RAM preamble may include some or all contents of message 1 (e.g., a PRACH preamble), and the RAM payload may include some or all contents of message 3 (e.g., a UE identifier, UCI, and/or a PUSCH transmission).

As shown by reference number 520, the network node 110 may receive the RAM preamble transmitted by the UE 120. If the network node 110 successfully receives and decodes the RAM preamble, the network node 110 may then receive and decode the RAM payload.

As shown by reference number 525, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 530, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 535, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 540, if the UE 120 successfully receives the RAR, the UE 120 may transmit a HARQ ACK.

As indicated above, FIG. 5 is provided as an example. Other examples may differ from what is described with regard to FIG. 5.

As described herein, NES and/or network energy efficiency measures are expected to have increased importance in wireless network operations for various reasons, such as climate change mitigation, environmental sustainability, and/or network cost reduction, among other examples. For example, although 5G NR generally offers a significant energy efficiency improvement per gigabyte over previous generations, some NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth of the total cost to operate a wireless network, and over 90% of network operating costs are spent on energy (e.g., fuel and electricity). The largest proportion of energy consumption and/or energy costs are associated with a RAN, which accounts for about half of the energy consumption in a wireless network, with data centers and fiber transport accounting for smaller shares. Accordingly, measures to increase network energy savings and/or improve network energy efficiency may drive adoption and/or expansion of wireless networks.

One technique to increase energy efficiency in a RAN is to enable “on-demand” broadcast transmissions by a network node and/or a cell. For example, to reduce power consumption at a network node, the network node may transmit certain broadcast communications (e.g., system information communications, an SSB, and/or one or more SIBs) in an on-demand manner (e.g., upon request, rather than on a periodic basis or following a periodic schedule). In some examples, the on-demand communication may be a communication that carries RMSI, such as SIB1 or another SIB (e.g., as defined, or otherwise fixed, by a wireless communication standard, such as the 3GPP). In some examples, one or more SSBs and/or SIB1 may be transmitted via a cell to support initial access, measurement, camping, and/or cell selection or reselection by a UE. Typically, such communications are periodically broadcasted via the cell (e.g., following a periodic schedule where the communication(s) are transmitted one or more times, and often beamswept in multiple beam directions, in each period) so that idle and/or inactive UEs and/or UEs moving into a geographic region of a cell can receive the communications and establish a connection via the cell. Therefore, one way to reduce network power consumption is to reduce transmissions of such communications such that, for example, SSBs and SIB1s are transmitted less frequently by a cell.

For example, a cell may operate in an NES mode or an NES state associated with an on-demand SIB1, where a SIB1 is transmitted only upon request by a UE, in order to reduce overhead and/or reduce power consumption. For example, a cell may operate in an NES mode or an NES state associated with an on-demand SIB1 during periods with low activity (e.g., there are not many UEs entering and exiting the coverage of the cell, or there are not many UEs that are attempting to establish a connection), in which case periodically broadcasting SIB1 (e.g., every 20 or 160 milliseconds) may be wasteful. In such cases, the cell may broadcast SIB1 only on-demand, or only upon request by a UE, where the request may be carried in an UL-WUS. For example, a UE in an idle or inactive mode or a UE that has detected or selected the cell operating in accordance with the on-demand SIB1 configuration may transmit an UL-WUS to the cell to request and acquire SIB1 (e.g., in order to camp on the cell, connect to the cell, or prepare to connect to the cell). In particular, the UE may generally transmit the UL-WUS in an occasion when the cell is monitoring for the UL-WUS, such that the cell may transition to a more active state and transmit the on-demand SIB1 upon detecting the UL-WUS in a monitoring occasion.

Various aspects described herein generally relate to techniques for configuring an UL-WUS and random access to enable NES. For example, as described herein, the UL-WUS may be associated with various parameters that may be the same as or similar to an initial message associated with a RACH procedure, such as a msg1 of a four-step RACH procedure or a msgA preamble of a two-step RACH procedure. For example, a msg1 or a msgA preamble is typically the first message that a UE transmits to a cell in order to identify the UE and start a RACH procedure to establish a connection to the cell. Accordingly, some aspects described herein relate to techniques for indicating UL-WUS and RACH configurations and occasions. For example, in some aspects, an NES cell associated with an on-demand SIB1 configuration may support separate configurations and occasions for an UL-WUS and an initial message used to start a RACH procedure (e.g., a msg1 or a msgA preamble). In this way, the NES cell may also support on-demand RACH monitoring, where the NES cell monitors a RACH occasion only in cases where a UE transmits an UL-WUS that includes a request to start a RACH procedure. Furthermore, in some aspects, the UL-WUS may be associated with different formats or identifiers, which may be used to indicate whether the UE is only requesting SIB1 (e.g., such that the NES cell does not need to monitor upcoming RACH occasions), only starting a RACH procedure (e.g., such that the NES cell does not need to transmit SIB1), or requesting SIB1 and starting a RACH procedure. Additionally, or alternatively, the NES cell may support shared UL-WUS and RACH configurations and occasions (e.g., where the UL-WUS shares many parameters and shares occasions with a msg1 or a msgA preamble). In such cases, an anchor cell may provide a UE with parameters for selecting or reselecting the NES cell, and the on-demand SIB1 may provide only a delta between the parameters indicated by the anchor cell and the minimum system information needed to establish a connection to the NES cell. Furthermore, some aspects described herein relate to techniques to configure retransmissions and transmit power parameters for a msg1 or a msgA preamble independently from or in accordance with a number of retransmissions and transmit power parameters used for the UL-WUS.

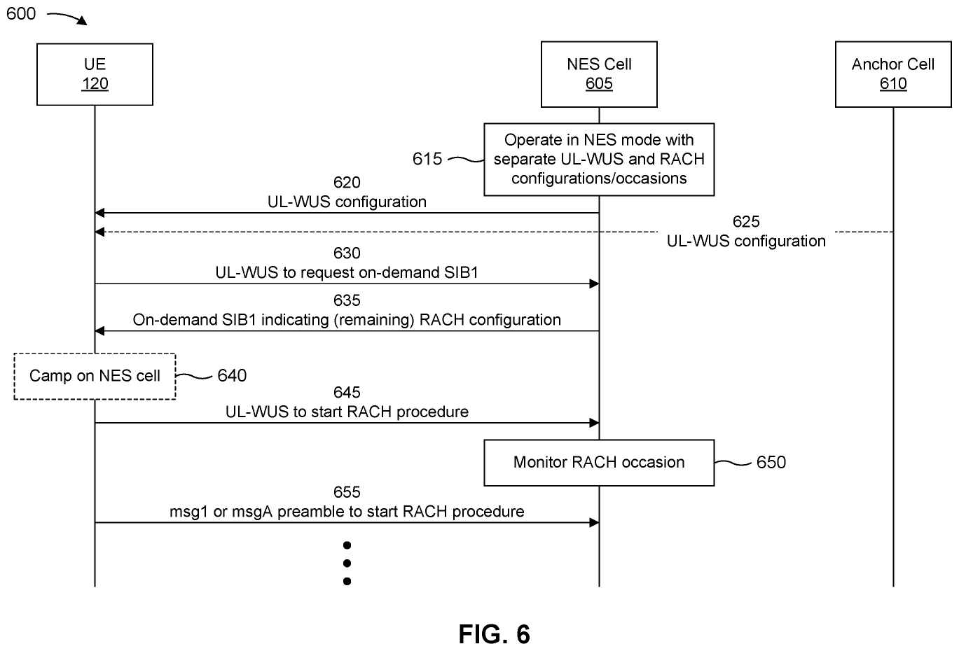

FIG. 6 is a diagram illustrating an example 600 associated with separate UL-WUS and random access configurations and occasions to enable NES, in accordance with the present disclosure. As shown in FIG. 6, example 600 includes communication between an NES cell 605 and a UE 120. As described herein, “NES cell” (e.g., the NES cell 605) refers to any suitable cell (or a network node 110) that is operating in an NES mode (or NES state) associated with one or more techniques to reduce power consumption. In some aspects, the NES cell 605 may be associated with an unanchored deployment (e.g., where the NES cell 605 does not rely upon another cell to assist and/or control operations of the NES cell 605). Alternatively, in some aspects, the NES cell may be associated with an anchored deployment. For example, as shown in FIG. 6, example 600 may optionally include communication between an anchor cell 610 and the UE 120, where the anchor cell 610 is configured to assist and/or control operations of the NES cell 605. For example, the anchor cell 610 may be a primary cell (PCell) and the NES cell 605 may be a secondary cell (SCell). For example, in carrier aggregation, the UE 120 may be configured with a primary carrier or PCell and one or more secondary carriers or SCells. In some aspects, the PCell may carry control information (e.g., downlink control information and/or scheduling information) for scheduling data communications on one or more SCells. Additionally, or alternatively, in an anchored deployment, the anchor cell 610 may be a serving cell for the UE 120, and the NES cell 605 may be a neighbor cell for the UE 120. In some examples, the NES cell 605 and the anchor cell 610 may be associated with (e.g., controlled by or supported by) the same network node 110. In other examples, the NES cell 605 and the anchor cell 610 may be controlled by or supported by different network nodes 110.

As shown in FIG. 6, and by reference number 615, the NES cell 605 may operate in an NES mode associated with separate UL-WUS and RACH configurations and occasions. For example, the NES cell 605 may operate in an NES mode in which the NES cell 605 transmits SIB1, sometimes referred to as RMSI, in an on-demand manner to reduce power or otherwise conserve energy resources. For example, as described herein, the UE 120 may need to acquire SIB1 in order to connect to the NES cell 605 (e.g., to enter an RRC connected mode) and/or to camp on the NES cell 605 (e.g., in cases where the NES cell 605 supports camping). Accordingly, in some cases, the UE 120 may transmit an UL-WUS to the NES cell 605 while the UE 120 is in an idle mode or an inactive mode to request the on-demand SIB1 transmission (e.g., in order to camp on the cell, connect to the cell, or prepare to connect to the cell). In particular, the UE 120 may generally transmit the UL-WUS in an occasion when the cell is monitoring for the UL-WUS, such that the cell may transition to a more active state and transmit the on-demand SIB1 upon detecting the UL-WUS in a monitoring occasion. Furthermore, in cases where the UE 120 is attempting to connect to the NES cell 605, the UE 120 may also need to transmit a msg1 or msgA preamble to initiate a RACH procedure in the NES cell 605. Accordingly, the NES cell 605 may also need to monitor one or more occasions in which the UE 120 can transmit the msg1 or msgA preamble. In some aspects, as described herein, the NES cell 605 may support separate configurations and occasions for an UL-WUS and RACH msg1 or msgA preamble.

Accordingly, in some aspects, supporting separate configurations and occasions for an UL-WUS and RACH msg1 or msgA preamble (e.g., a first configuration and a first set of occasions for the UL-WUS and a second configuration and a second set of occasions for the RACH msg1 or msgA preamble) may enable a more compact UL-WUS configuration in a time domain and/or a more energy-efficient UL-WUS configuration. For example, the NES cell 605 may need to support several UL-WUS occasions in multi-beam operation, such as 64 UL-WUS occasions for a multi-beam configuration with 64 beams. In such cases, supporting separate UL-WUS and RACH configurations and occasions may allow the NES cell 605 to schedule an UL-WUS burst where various UL-WUS occasions are configured in a more compact manner (e.g., over consecutive symbols or slots). In this way, the NES cell 605 can periodically transition to a more active state to monitor the UL-WUS occasions for a more compact duration, and then return to a sleep state or other lower power state sooner, as compared to a scenario where the UL-WUS occasions are staggered or distributed in the time domain (e.g., because there would be gaps between the staggered or distributed UL-WUS occasions that prevent the NES cell 605 from enabling any meaningful power savings between UL-WUS occasions that have to be monitored).

Furthermore, as described herein, supporting separate UL-WUS and RACH msg1 or msgA preamble configurations and occasions may allow many UL-WUS parameters to be fixed or otherwise defined (e.g., in a wireless communication standard), which may enable an unanchored deployment for the NES cell 605 associated with the on-demand SIB1. For example, a subcarrier spacing for a RACH msg1 or msgA preamble is typically configurable, and SIB1 includes a few bits that are used to indicate the subcarrier spacing for a RACH msg1 or msgA preamble. However, for UL-WUS, a subcarrier spacing may be fixed or static for one or more frequency ranges or frequency bands, which may reduce the amount of over-the-air signaling that is needed to indicate an UL-WUS configuration to the UE 120. Accordingly, in cases where many UL-WUS parameters are fixed or otherwise defined, there may be only a few remaining UL-WUS parameters that need to be indicated to the UE 120. For example, in some aspects, the remaining UL-WUS parameters that are not fixed or otherwise defined may be reduced to a number of bits that satisfies (e.g., is less than or equal to) a threshold (e.g., 10 bits or 20 bits) that the NES cell 605 can independently indicate without the assistance or support of an anchor cell (e.g., the anchor cell 610). For example, in some aspects, the NES cell 605 may be configured to transmit an SSB (e.g., carrying a primary synchronization signal (PSS) and physical broadcast channel (PBCH)), a PDCCH, and/or other suitable signaling with a payload size that can convey the remaining UL-WUS parameters, which may allow the NES cell 605 to operate in an unanchored (e.g., standalone) deployment without assistance from any other cells.

Accordingly, as further shown in FIG. 6, and by reference number 620, the NES cell 605 may transmit, and the UE 120 may receive, information that indicates an UL-WUS configuration associated with the NES cell 605. For example, in some aspects, the UL-WUS configuration may include various UL-WUS parameters, such as a subcarrier spacing, a timing advance offset, a time division duplexing (TDD) configuration, a position of one or more SSBs in a burst, a PBCH block power, or the like. In some cases, various UL-WUS parameters associated with the UL-WUS configuration may be fixed or otherwise defined (e.g., in a wireless communication standard), and the UL-WUS configuration may be transmitted in an SSB or other suitable signaling to indicate any remaining (e.g., configurable) UL-WUS parameters. Furthermore, in some aspects, the UL-WUS configuration may indicate a set of UL-WUS occasions (e.g., uplink resources in a frequency domain and/or a time domain) in which the UE 120 can transmit an UL-WUS, which may be separate from RACH occasions in which the UE 120 can transmit a RACH msg1 or a msgA preamble.

Additionally, or alternatively, as shown in FIG. 6, and by reference number 625, the anchor cell 610 may transmit, and the UE 120 may receive, information that indicates the UL-WUS configuration associated with the NES cell 605 (e.g., in an anchored deployment). For example, in some aspects, the anchor cell 610 may transmit the UL-WUS configuration to indicate any UL-WUS parameters that the NES cell 605 is unable to fit into a payload of an SSB or other suitable signaling that is provided to enable initial access to the NES cell 605 prior to a SIB1 transmission. For example, in some aspects, the UL-WUS configuration provided by the anchor cell 610 may include one or more parameters for the UE 120 to select or reselect the NES cell 605 and/or may indicate the uplink resources that correspond to the UL-WUS occasions in which the UE 120 can transmit an UL-WUS.

As further shown in FIG. 6, and by reference number 630, the UE 120 may transmit an UL-WUS to the NES cell 605 in an UL-WUS occasion to request transmission of the on-demand SIB1. For example, as described herein, the UL-WUS configuration may include different formats or identifiers for the UL-WUS, which may indicate a purpose of the UL-WUS transmitted by the UE 120. For example, in cases where the NES cell 605 supports camping on the NES cell 605 (e.g., while the UE 120 is an idle or inactive state and the UE 120 does not have uplink data to transmit or downlink data to receive), the UE 120 may request the on-demand SIB1 to enable camping on the NES cell 605 (e.g., such that the UE 120 can enter the connected mode and/or the NES cell 605 can page the UE 120 when there is uplink and/or downlink traffic to communicate). For example, the minimum requirement for the UE 120 to camp on the NES cell 605 (if camping is allowed) is to decode a master information block (MIB) and SIB1, where the MIB may be carried in a PBCH transmitted by the NES cell 605 or the anchor cell 610 and the SIB1 is transmitted by the NES cell 605 on-demand (e.g., upon request). Additionally, or alternatively, the UE 120 may transmit the UL-WUS to request the on-demand SIB1 in order to obtain the necessary information to connect to the NES cell 605 (e.g., to communicate uplink and/or downlink traffic), in which case the UE 120 may need to start a RACH procedure after acquiring the on-demand SIB1. Additionally, or alternatively, in cases where the NES cell 605 does not support camping and/or the UE 120 is camping on a different cell (e.g., the anchor cell 610 or another cell), the UE 120 may transmit the UL-WUS to request the on-demand SIB1 in order to obtain the necessary information to connect to the NES cell 605 at a later time when there is uplink and/or downlink traffic.

In some aspects, because there may be instances where the UE 120 transmits the UL-WUS only to request the on-demand SIB1 (e.g., in order to camp on the NES cell 605 or prepare for a RACH procedure to be initiated at a later time) and RACH occasions are configured separately from UL-WUS occasions, the NES cell 605 may be configured to support on-demand monitoring for the RACH occasions. For example, if the NES cell 605 were to monitor both the UL-WUS occasions and the RACH occasions at all times, the opportunities for the NES cell 605 to conserve energy may be reduced (e.g., because the NES cell 605 would have to monitor the UL-WUS occasions to determine whether any UE 120 is requesting the on-demand SIB1 and monitor the RACH occasions to determine whether any UE 120 is attempting to start a RACH procedure). Accordingly, in some aspects, the NES cell 605 may support on-demand monitoring for RACH occasions, and an UL-WUS transmitted in an UL-WUS occasion may be associated with a format or identifier to indicate whether the UL-WUS includes only a request for the on-demand SIB1, only a request to start a RACH procedure, or a request for the on-demand SIB1 and a request to start a RACH procedure. In this way, the NES cell 605 may always monitor UL-WUS occasions, and may refrain from monitoring RACH occasions unless an UL-WUS transmitted in an UL-WUS occasion is associated with a format or identifier to indicate that the UL-WUS includes a request to start a RACH procedure.

For example, in the scenario shown in FIG. 6, where the UE 120 has not yet acquired SIB1 at the time that the UE 120 transmits the UL-WUS in the UL-WUS occasion corresponding to reference number 630, the UL-WUS may be associated with a format or identifier to indicate that the UE 120 is only requesting the on-demand SIB1 if the UE 120 is not attempting to enter a connected mode on the NES cell 605 (e.g., to camp on the NES cell 605, if allowed, and/or to ensure that the UE 120 is prepared to start a RACH procedure at a later time, regardless of whether camping on the NES cell 605 is allowed or barred). Alternatively, the UL-WUS may be associated with a format or identifier to indicate that the UE 120 is requesting the on-demand SIB1 and requesting to start a RACH procedure, if the UE 120 is requesting the on-demand SIB1 in order to obtain the necessary system information needed to start a RACH procedure and enter a connected mode on the NES cell 605.

As further shown in FIG. 6, and by reference number 635, the NES cell 605 may transmit, and the UE 120 may receive, the on-demand SIB1 associated with the NES cell 605. For example, in some aspects, the on-demand SIB1 may include content associated with the RACH configuration for the NES cell 605, such as the RACH occasions in which the UE 120 can transmit a RACH msg1 or a msgA preamble to start a RACH procedure and various RACH parameters, such as a subcarrier spacing for the RACH msg1 or msgA preamble, a preamble format, a timing advance offset, and/or other suitable RACH parameters. In some aspects, in cases where the NES cell 605 is operating in a standalone or unanchored deployment, the on-demand SIB1 may include legacy or typical SIB1 content, such as cell selection information, cell access related information, connection establishment failure control parameters, information scheduling other SIBs, a serving cell common configuration, an emergency support indication, and/or values for one or more timers and/or constants, among other examples. Additionally, or alternatively, in some aspects, the on-demand SIB1 may include only the minimum system information that is needed to establish a connection to the NES cell 605 (e.g., RACH parameters, a timing offset advance parameter, a TDD common configuration, values of timers and/or constants applicable to a RACH procedure, and/or uplink and/or downlink bandwidth part parameters, among other examples), in which case the remaining SIB1 parameters may be provided to the UE 120 at a later time (e.g., after the UE 120 has established a connection to the NES cell 605). Additionally, or alternatively, in cases where the NES cell 605 is associated with an unanchored deployment or the anchor cell 610 otherwise provides the UL-WUS configuration to the UE 120, the UL-WUS configuration may include various SIB1 parameters, such as parameters that are used to detect, select, or reselect the NES cell 605. In such cases, the on-demand SIB1 may include only the remaining minimum system information (e.g., that is not provided in the UL-WUS configuration) needed to establish a connection to the NES cell 605.

For example, as described herein, the initial UL-WUS configuration provided by the NES cell 605 (e.g., in an unanchored deployment) and/or the anchor cell 610 (e.g., in an anchored deployment) may include only a set of parameters that are needed or partially needed for the UE 120 to transmit the UL-WUS in an appropriate UL-WUS occasion and/or for the UE 120 to detect, select, or reselect the NES cell 605. For example, in some aspects, the set of parameters included in the UL-WUS configuration may include a set of information elements (IEs) associated with a ServingCellConfigCommonSIB parameter (e.g., an n-TimingAdvanceOffset IE, an ssb-PositionsInBurst IE, an ssb-PeriodicityServingCell IE, a tdd-UL-DL-ConfigurationCommon IE, and an ss-PBCH-BlockPower IE), a set of IEs associated with an uplinkConfigCommonSIB parameter (e.g., a frequencyInfoUL IE and an initialUplinkBWP IE), and/or a set of IEs associated with an initialUplinkBWP parameter (a RACH-ConfigCommon IE, a PUSCH-ConfigCommon IE, and a PUCCH-ConfigCommon IE). Additionally, or alternatively, in some aspects, the initial UL-WUS configuration may optionally further include one or more parameters that are beneficial for the UL-WUS, such as a set of IEs associated with a cellAccessRelatedInfo parameter (e.g., a cellReservedForOtherUse or cellReservedForFutureUse-r16 IE), a set of IEs associated with a PLMN-IdentityInfoList parameter (e.g., a plmn-IdentityList IE, a cellReservedForOperatorUse IE, and an iab-Support-r16 IE), and/or a set of IEs associated with a uac-BarringInfo parameter (a uac-BarringForCommon IE, a uac-BarringPerPLMN-List IE, and/or a uac-AccessCategoryl-SelectionAssistanceInfo IE). Alternatively, in some aspects, the one or more parameters that are beneficial for the UL-WUS, but not needed, may be provided in the on-demand SIB1. Furthermore, in some aspects, one or more parameters that are excluded from the UL-WUS configuration and instead provided in the on-demand SIB1 may include a set of IEs associated with a frequencyInfoDL-SIB parameter (e.g., an offsetToPointA IE and/or an scs-SpecificCarrierList IE), a set of IEs associated with a BWP-DownlinkCommon parameter (e.g., a pdcch-ConfigCommon IE that includes an ra-searchSpace and/or a pdsch-ConfigCommon IE that includes a PDSCH-TimeDomainResourceAllocationList IE), a set of IEs associated with a ue-TimersAndConstants parameter (e.g., a T300 timer that starts when the UE 120 transmits an RRCSetupRequest and/or a T319 that starts when the UE 120 transmits an RRCResumeRequest), and/or a useFullResumeID IE that includes a true or false indication.

As further shown in FIG. 6, and by reference number 640, the UE 120 may optionally camp on the NES cell 605, if the NES cell 605 supports or otherwise allows camping on the NES cell 605. For example, in some aspects, a minimum requirement for the UE 120 to camp on the NES cell 605 (if allowed) may be to acquire and decode a MIB and SIB1 associated with the NES cell 605. Accordingly, in cases where camping is allowed on the NES cell 605 and the UE 120 does not have uplink traffic to transmit and/or downlink traffic to receive, the UE 120 may camp on the NES cell 605 in an idle or inactive state until the UE 120 has uplink traffic to transmit and/or downlink traffic. In such cases, the NES cell 605 may support paging the UE 120 (e.g., to indicate that there is uplink and/or downlink traffic for the UE 120, such that the UE 120 is to start a RACH procedure to connect to the NES cell 605). Alternatively, in some aspects, the NES cell 605 may bar camping on the NES cell 605, in which case the UE 120 may be camping on the anchor cell 610 or a different cell. In such cases, when camping on the NES cell 605 is not allowed, the NES cell 605 does not have to support paging the UE 120 or any other UEs, which may allow the NES cell 605 to further reduce power consumption or otherwise conserve energy. Alternatively, in some aspects, the NES cell 605 may support camping, but the UE 120 may camp on the anchor cell 610 or another suitable cell. Alternatively, in cases where the UE 120 has uplink traffic to transmit and/or downlink traffic to receive, the UE 120 may refrain from camping on the NES cell 605 and may instead proceed with the appropriate actions to start a RACH procedure to enter into a connected mode on the NES cell 605.

As further shown in FIG. 6, and by reference number 645, the UE 120 may transmit, and the NES cell 605 may receive, an UL-WUS that includes a request to start a RACH procedure, where the UL-WUS may be transmitted in an UL-WUS occasion. For example, in some aspects, the UE 120 may generally transmit the UL-WUS that includes the request to start the RACH procedure after acquiring the on-demand SIB1 that includes at least the remaining minimum system information needed to start the RACH procedure. In some aspects, the UL-WUS that includes the request to start the RACH procedure may be transmitted while the UE 120 is camping on the NES cell 605 or while the UE 120 is camping on the anchor cell 610 or a different cell prior to starting the RACH procedure to enter a connected mode on the NES cell 605. Accordingly, as shown by reference number 650, the NES cell 605 may start to monitor RACH occasions for a msg1 or msgA preamble transmission by the UE 120 based on the UL-WUS including the request to start the RACH procedure. Furthermore, in cases where the UE 120 has already acquired the on-demand SIB1 prior to transmitting the UL-WUS that includes the request to start the RACH procedure, the UL-WUS may be associated with a format or identifier to indicate that the UL-WUS only includes the request to start the RACH procedure (e.g., the UE 120 does not need the NES cell 605 to transmit the on-demand SIB1). In this way, when the UE 120 transmits an UL-WUS that includes only a request to start the RACH procedure, the NES cell 605 may start to monitor RACH occasions for the msg1 or msgA preamble transmission from the UE 120 and may conserve power by refraining from transmitting the on-demand SIB1.

As further shown in FIG. 6, and by reference number 655, the UE 120 may then transmit a msg1 or msgA preamble to start the RACH procedure in a suitable RACH occasion, where the msg1 or msgA preamble has a separate configuration from the UL-WUS and the RACH occasion is separate from any UL-WUS occasions that are configured for the NES cell 605. Furthermore, in some aspects, the RACH configuration may include support for one or more retransmissions of the msg1 or msgA preamble, and the UL-WUS configuration associated with the NES cell 605 may or may not support retransmission of the UL-WUS. In some aspects, in cases where the NES cell 605 supports retransmission of the UL-WUS, the retransmission configuration for the UL-WUS may include similar parameters (e.g., with the same or different values) as a msg1 or msgA preamble repetition configuration.

In some aspects, prior to transmitting the msg1 or msgA preamble to start the RACH procedure, the UE 120 may generally transmit one or more UL-WUSs to acquire the on-demand SIB1 and/or indicate the request to start the RACH procedure. In some aspects, when the UE 120 transmits the msg1 or msgA preamble, the UE 120 may use a transmit power and/or a number of repetitions for the msg1 or msgA preamble that is independent from the transmit power and/or the number of repetitions that were used for the UL-WUS transmission(s). For example, in cases where the transmit power and/or the number of repetitions for the msg1 or msgA preamble is independent from the transmit power and/or the number of repetitions that were used for the UL-WUS transmission(s), the UE 120 may follow a legacy configuration (e.g., indicated in the on-demand SIB1) for transmit power ramping and/or the maximum number of repetitions for the msg1 or msgA preamble transmission(s). Alternatively, in some aspects, the transmit power and/or power ramping and/or number of repetitions for the msg1 or msgA preamble transmission may be based at least in part on the transmit power of the last UL-WUS transmitted by the UE 120 and/or the number of times that the UE 120 transmitted a repetition or a retransmission of the UL-WUS. For example, in cases where the UE 120 transmitted the UL-WUS multiple times and/or applied power ramping to subsequent transmissions of the UL-WUS, the UE 120 may not reset a counter when starting the msg1 or msgA preamble transmissions. Instead, in such cases, the first msg1 or msgA preamble transmitted by the UE 120 may be based on the repetition factor and/or transmit power of the last UL-WUS. Additionally, or alternatively, the UE 120 may adjust a power ramping step that is used for one or more retransmissions of the msg1 or msgA preamble such that the UE 120 will not exceed a maximum accumulated power ramp after reaching the maximum number of retransmissions that are allowed for the msg1 or msgA preamble. Alternatively, in some aspects, the UE 120 may adjust the maximum number of retransmissions for the msg1 or msgA preamble to avoid exceeding the maximum accumulated power ramp. Alternatively, in some aspects, the UE 120 may use the same maximum number of retransmissions and/or power ramping step for the msg1 or msgA preamble, but May not further increase the transmit power for retransmissions of the msg1 or msgA preamble that occur after reaching the maximum accumulated power ramp.

As indicated above, FIG. 6 is provided as an example. Other examples may differ from what is described with regard to FIG. 6.

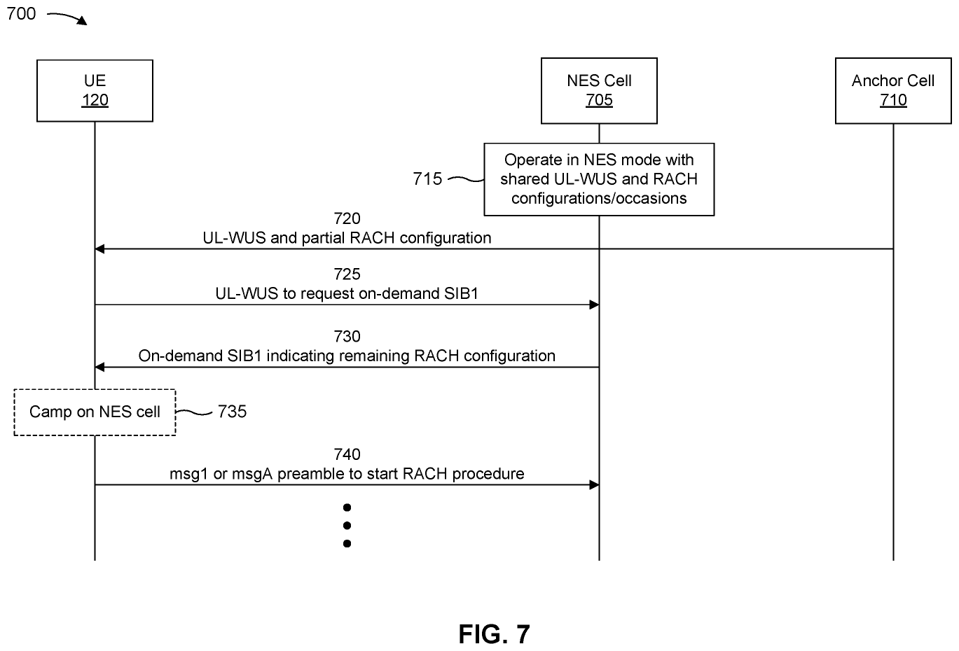

FIG. 7 is a diagram illustrating an example 700 associated with shared UL-WUS and random access configurations and occasions to enable NES, in accordance with the present disclosure. As shown in FIG. 7, example 700 includes communication between an NES cell 705, an anchor cell 710, and a UE 120. In some aspects, as described herein, the NES cell 705 may be associated with an anchored deployment. For example, in some aspects, the anchor cell 710 is configured to assist and/or control operations of the NES cell 605. For example, the anchor cell 610 may be a PCell and the NES cell 705 may be an SCell (e.g., in a carrier aggregation configuration). Additionally, or alternatively, the anchor cell 710 may be a serving cell for the UE 120, and the NES cell 705 may be a neighbor cell for the UE 120. In some examples, the NES cell 705 and the anchor cell 710 may be associated with (e.g., controlled by or supported by) the same network node 110. In other examples, the NES cell 705 and the anchor cell 710 may be controlled by or supported by different network nodes 110.

As shown in FIG. 7, and by reference number 715, the NES cell 705 may operate in an NES mode associated with shared UL-WUS and RACH occasions, and an UL-WUS configuration may share various parameters with a RACH configuration. For example, the NES cell 705 may operate in an NES mode in which the NES cell 705 transmits SIB1 in an on-demand manner to reduce power or otherwise conserve energy resources. For example, as described herein, the UE 120 may need to acquire SIB1 in order to connect to the NES cell 705 (e.g., to enter an RRC connected mode) and/or to camp on the NES cell 705 (e.g., in cases where the NES cell 705 supports camping). Accordingly, in some cases, the UE 120 may transmit an UL-WUS to the NES cell 705 while the UE 120 is in an idle mode or an inactive mode to request the on-demand SIB1 transmission (e.g., in order to camp on the cell, connect to the cell, or prepare to connect to the cell). In particular, the UE 120 may generally transmit the UL-WUS in a shared UL-WUS and RACH occasion when the cell is monitoring for the UL-WUS and for RACH msg1 or msgA preamble transmissions, such that the cell may transition to a more active state and transmit the on-demand SIB1 upon detecting the UL-WUS and/or a RACH msg1 or msgA preamble transmission in a shared monitoring occasion.

Accordingly, in some aspects, supporting shared occasions for an UL-WUS and RACH msg1 or msgA preamble and UL-WUS and RACH configurations that share at least some parameters may limit the NES cell 705 to an anchored deployment. For example, because many RACH parameters are configurable, partially sharing parameters for the UL-WUS and RACH configuration may limit the number of UL-WUS parameters that can be fixed or otherwise defined (e.g., in a wireless communication standard). As a result, the shared occasions and partially shared configurations for the UL-WUS and RACH msg1 or msgA preamble may limit the NES cell 705 to an anchored deployment (e.g., because an SSB, or other signaling that the NES cell 705 always transmits, may not have a sufficient payload size to indicate all of the configurable parameters that are shared by the UL-WUS and RACH msg1 or msgA preamble). Alternatively, the NES cell 705 may support an unanchored deployment only in cases where many RACH parameters are also fixed or otherwise defined, such that the configurable parameters that are shared by the UL-WUS and RACH msg1 or msgA preamble are reduced to a number of bits that can fit within the payload size of an SSB or other always-on signaling associated with the NES cell 705.

Accordingly, as shown in FIG. 7, and by reference number 720, the anchor cell 710 may transmit, and the UE 120 may receive, information that indicates the shared occasions associated with the UL-WUS and RACH msg1 or msgA preamble and information that indicates the UL-WUS configuration associated with the NES cell 705. For example, in some aspects, the UL-WUS configuration transmitted by the anchor cell 710 may indicate various parameters that the UE 120 is to use to transmit the UL-WUS, which may include various parameters that are shared with a RACH msg1 or msgA preamble. In some aspects, the UL-WUS information that indicates the UL-WUS configuration may correspond to a partial RACH configuration, or may include various parameters that are shared by the UL-WUS and RACH configuration. Additionally, or alternatively, the configuration information provided by the anchor cell 710 may include a portion of the content associated with a legacy or typical SIB1, such as parameters to enable selection or reselection of the NES cell 705 and/or parameters to enable camping on the NES cell 705 (if allowed). Accordingly, as described herein, the configuration information provided by the anchor cell 710 may generally indicate the uplink resources (e.g., frequency and/or time resources) associated with the shared occasions in which the UE 120 can transmit an UL-WUS or RACH msg1 or msgA preamble toward the NES cell 705 and a subset of the content associated with a legacy or typical SIB1, which includes a set of parameters that are shared by UL-WUS and RACH msg1 or msgA preamble configurations and/or other suitable parameters.

For example, as described herein, the initial UL-WUS and partial RACH configuration provided by the anchor cell 710 may include only a set of parameters that are needed or partially needed for the UE 120 to transmit the UL-WUS in an appropriate shared UL-WUS/RACH occasion and/or for the UE 120 to detect, select, or reselect the NES cell 705. For example, in some aspects, the set of parameters included in the UL-WUS and partial RACH configuration may include a set of IEs associated with a ServingCellConfigCommonSIB parameter (e.g., an n-TimingAdvance Offset IE, an ssb-PositionsInBurst IE, an ssb-PeriodicityServingCell IE, a tdd-UL-DL-ConfigurationCommon IE, and an ss-PBCH-BlockPower IE), a set of IEs associated with an uplinkConfigCommonSIB parameter (e.g., a frequencyInfoUL IE and an initialUplinkBWP IE), and/or a set of IEs associated with an initialUplinkBWP parameter (a RACH-ConfigCommon IE, a PUSCH-ConfigCommon IE, and a PUCCH-ConfigCommon IE). Additionally, or alternatively, in some aspects, the initial UL-WUS and partial RACH configuration may optionally further include one or more parameters that are beneficial for the UL-WUS, such as a set of IEs associated with a cellAccessRelatedInfo parameter (e.g., a cellReservedForOtherUse or cellReservedForFutureUse-r16 IE), a set of IEs associated with a PLMN-IdentityInfoList parameter (e.g., a plmn-IdentityList IE, a cellReservedForOperatorUse IE, and an iab-Support-r16 IE), and/or a set of IEs associated with a uac-BarringInfo parameter (a uac-BarringForCommon IE, a uac-BarringPerPLMN-List IE, and/or a uac-AccessCategoryl-SelectionAssistanceInfo IE).

As further shown in FIG. 7, and by reference number 725, the UE 120 may transmit an UL-WUS to the NES cell 705 in an UL-WUS occasion to request transmission of the on-demand SIB1. For example, as described herein, the UL-WUS may be transmitted in an occasion that is shared by UL-WUS and RACH msg1 or msgA preamble transmissions, and may include one or more parameters (e.g., a subcarrier spacing, timing advance offset, or the like) that are shared with RACH msg1 or msgA preamble transmissions. Furthermore, because the UL-WUS and RACH msg1 or msgA preamble share various parameters, and either of the UL-WUS and RACH msg1 or msgA preamble can be transmitted in a shared occasion monitored by the NES cell 705, the UL-WUS may include one or more parameters to differentiate the UL-WUS from a RACH msg1 or msgA preamble (e.g., the UL-WUS may occupy time and/or frequency resources that are different from a RACH msg1 or msgA preamble transmission).

As further shown in FIG. 7, and by reference number 730, the NES cell 605 may then transmit, and the UE 120 may receive, the on-demand SIB1 associated with the NES cell 705 based on the UL-WUS. For example, in some aspects, the on-demand SIB1 may include a remaining RACH configuration for the NES cell 705, which may enable the UE 120 to transmit a RACH msg1 or msgA preamble to start a RACH procedure. Furthermore, because the configuration information provided by the anchor cell 710 includes various parameters that are shared by the UL-WUS and RACH msg1 or msgA preamble and/or other content associated with a legacy SIB1 (e.g., parameters related to camping on the NES cell 705), the on-demand SIB1 transmitted by the NES cell 705 may include only the remaining minimum system information that is needed to establish a connection to the NES cell 705. For example, as described herein, the on-demand SIB1 may include only a delta between the configuration information provided by the anchor cell 710 and a set of parameters that are needed to establish a connection to the NES cell 705.

For example, in some aspects, the on-demand SIB1 may include a set of IEs associated with a frequencyInfoDL-SIB parameter (e.g., an offsetToPointA IE and/or an scs-SpecificCarrierList IE), a set of IEs associated with a BWP-DownlinkCommon parameter (e.g., a pdcch-ConfigCommon IE that includes an ra-searchSpace and/or a pdsch-ConfigCommon IE that includes a PDSCH-TimeDomainResourceAllocationList IE), a set of IEs associated with a ue-TimersAndConstants parameter (e.g., a T300 timer that starts when the UE 120 transmits an RRCSetupRequest and/or a T319 that starts when the UE 120 transmits an RRCResumeRequest), and/or a useFullResumeID IE that includes a true or false indication. Additionally, or alternatively, the on-demand SIB1 may include one or more optional parameters that are beneficial, but not needed, for the UL-WUS in cases where such parameters are not included in the initial UL-WUS and partial RACH configuration. For example, as described herein, the one or more optional parameters that may be indicated in either the UL-WUS and partial RACH configuration or the on-demand SIB1 may include a set of IEs associated with a cellAccessRelatedInfo parameter (e.g., a cellReservedForOtherUse or cellReservedForFutureUse-r16 IE), a set of IEs associated with a PLMN-IdentityInfoList parameter (e.g., a plmn-IdentityList IE, a cellReservedForOperatorUse IE, and an iab-Support-r16 IE), and/or a set of IEs associated with a uac-BarringInfo parameter (a uac-BarringForCommon IE, a uac-BarringPerPLMN-List IE, and/or a uac-AccessCategoryl-SelectionAssistanceInfo IE).

As further shown in FIG. 7, and by reference number 735, the UE 120 may optionally camp on the NES cell 705, if the NES cell 705 supports or otherwise allows camping on the NES cell 705. For example, in some aspects, a minimum requirement for the UE 120 to camp on the NES cell 705 (if allowed) may be to acquire and decode a MIB and SIB1 associated with the NES cell 705. Accordingly, in cases where camping is allowed on the NES cell 705 and the UE 120 does not have uplink traffic to transmit and/or downlink traffic to receive, the UE 120 may camp on the NES cell 705 in an idle or inactive state until the UE 120 has uplink traffic to transmit and/or downlink traffic. In such cases, the NES cell 705 may support paging the UE 120 (e.g., to indicate that there is uplink and/or downlink traffic for the UE 120, such that the UE 120 is to start a RACH procedure to connect to the NES cell 705). Alternatively, in some aspects, the NES cell 705 may bar camping on the NES cell 705, in which case the UE 120 may camp on the anchor cell 710 or a different cell. In such cases, when camping on the NES cell 705 is not allowed, the NES cell 705 does not have to support paging the UE 120 or any other UEs, which may allow the NES cell 705 to further reduce power consumption or otherwise conserve energy. Alternatively, in some aspects, the NES cell 705 may support camping, but the UE 120 may camp on the anchor cell 710 or another suitable cell. Alternatively, in cases where the UE 120 has uplink traffic to transmit and/or downlink traffic to receive, the UE 120 may refrain from camping on the NES cell 705 and may instead proceed with the appropriate actions to start a RACH procedure to enter into a connected mode on the NES cell 705 (e.g., using the parameters provided in the on-demand SIB1).

As further shown in FIG. 7, and by reference number 740, the UE 120 may then transmit a msg1 or msgA preamble to start the RACH procedure in a suitable shared occasion associated with UL-WUS and RACH msg1 or msgA preamble transmissions. Furthermore, in some aspects, the RACH configuration may include support for one or more retransmissions of the msg1 or msgA preamble, and the UL-WUS configuration associated with the NES cell 705 may or may not support retransmission of the UL-WUS. In some aspects, in cases where the NES cell 705 supports retransmission of the UL-WUS, the retransmission configuration for the UL-WUS may include similar parameters (e.g., with the same or different values) as a msg1 or msgA preamble repetition configuration.

For example, prior to transmitting the msg1 or msgA preamble to start the RACH procedure, the UE 120 may generally transmit one or more UL-WUSs to acquire the on-demand SIB1. In some aspects, when the UE 120 transmits the msg1 or msgA preamble, the UE 120 may use a transmit power and/or a number of repetitions for the msg1 or msgA preamble that is independent from the transmit power and/or the number of repetitions that were used for the UL-WUS transmission(s). For example, in cases where the transmit power and/or the number of repetitions for the msg1 or msgA preamble are independent from the transmit power and/or the number of repetitions that were used for the UL-WUS transmission(s), the UE 120 may follow a legacy configuration (e.g., indicated in the on-demand SIB1) for transmit power ramping and/or the maximum number of repetitions for the msg1 or msgA preamble transmission(s). Alternatively, in some aspects, the transmit power and/or power ramping and/or number of repetitions for the msg1 or msgA preamble transmission may be based at least in part on the transmit power of the last UL-WUS transmitted by the UE 120 and/or the number of times that the UE 120 transmitted a repetition or a retransmission of the UL-WUS. For example, in cases where the UE 120 transmitted the UL-WUS multiple times and/or applied power ramping to subsequent transmissions of the UL-WUS, the UE 120 may not reset a counter when starting the msg1 or msgA preamble transmissions. Instead, in such cases, the first msg1 or msgA preamble transmitted by the UE 120 may be based on the repetition factor and/or transmit power of the last UL-WUS. Additionally, or alternatively, the UE 120 may adjust a power ramping step that is used for one or more retransmissions of the msg1 or msgA preamble such that the UE 120 will not exceed a maximum accumulated power ramp after reaching the maximum number of retransmissions that are allowed for the msg1 or msgA preamble. Alternatively, in some aspects, the UE 120 may adjust the maximum number of retransmissions for the msg1 or msgA preamble to avoid exceeding the maximum accumulated power ramp. Alternatively, in some aspects, the UE 120 may use the same maximum number of retransmissions and/or same power ramping step for the msg1 or msgA preamble, but may not further increase the transmit power for retransmissions of the msg1 or msgA preamble that occur after reaching the maximum accumulated power ramp.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with techniques for configuring an UL-WUS and random access to enable NES.

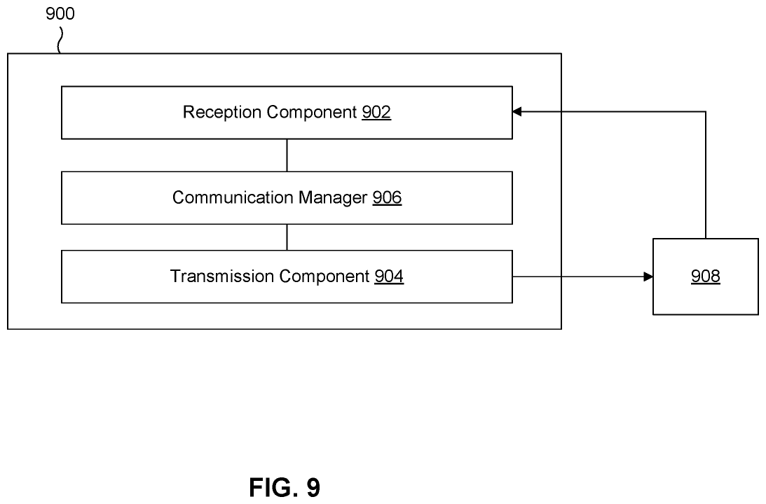

As shown in FIG. 8, in some aspects, process 800 may include receiving an UL-WUS configuration and a RACH configuration for an NES cell, wherein the NES cell is associated with an on-demand SIB1 (block 810). For example, the UE (e.g., using reception component 902 and/or communication manager 906, depicted in FIG. 9) may receive an UL-WUS configuration and a RACH configuration for an NES cell, wherein the NES cell is associated with an on-demand SIB1, as described above.

As further shown in FIG. 8, in some aspects, process 800 may include transmitting, to the NES cell, an UL-WUS in an UL-WUS occasion associated with the UL-WUS configuration, wherein the UL-WUS includes one or more of a request for the on-demand SIB1 or a request to start a RACH procedure (block 820). For example, the UE (e.g., using transmission component 904 and/or communication manager 906, depicted in FIG. 9) may transmit, to the NES cell, an UL-WUS in an UL-WUS occasion associated with the UL-WUS configuration, wherein the UL-WUS includes one or more of a request for the on-demand SIB1 or a request to start a RACH procedure, as described above.

Process 800 may include additional aspects, such as any single aspect or any combination of aspects described below and/or in connection with one or more other processes described elsewhere herein.

In a first aspect, process 800 includes transmitting, to the NES cell based on the UL-WUS including the request to start the RACH procedure, a message to initiate the RACH procedure in a RACH occasion associated with the RACH configuration.

In a second aspect, alone or in combination with the first aspect, the UL-WUS has a format or an identifier to indicate that the UL-WUS includes only the request to start the RACH procedure based on acquiring SIB1 associated with the NES cell prior to transmitting the UL-WUS.

In a third aspect, alone or in combination with one or more of the first and second aspects, process 800 includes receiving, from the NES cell, the on-demand SIB1 based on the UL-WUS including the request for the on-demand SIB1.

In a fourth aspect, alone or in combination with one or more of the first through third aspects, the UL-WUS has a format or an identifier to indicate that the UL-WUS includes the request for the on-demand SIB1 and the request to start the RACH procedure.

In a fifth aspect, alone or in combination with one or more of the first through fourth aspects, the message to initiate the RACH procedure is transmitted using a transmit power or a number of repetitions that is independent from a transmit power or a number of repetitions used to transmit the UL-WUS.

In a sixth aspect, alone or in combination with one or more of the first through fifth aspects, the UL-WUS is transmitted with power ramping over multiple repetitions, and the message to initiate the RACH procedure is transmitted using one or more of a transmit power associated with a last repetition, of the multiple repetitions of the UL-WUS, or with a maximum number of repetitions that is based on a number of the multiple repetitions of the UL-WUS.

In a seventh aspect, alone or in combination with one or more of the first through sixth aspects, process 800 includes adjusting a power ramping step associated with retransmissions of the message to initiate the RACH procedure to not exceed a maximum accumulated power ramp after the maximum number of repetitions.

In an eighth aspect, alone or in combination with one or more of the first through seventh aspects, the maximum number of repetitions is based on a power ramping step, a maximum accumulated power ramp, and the transmit power associated with the last repetition, of the multiple repetitions of the UL-WUS.

In a ninth aspect, alone or in combination with one or more of the first through eighth aspects, the transmit power is not increased for one or more repetitions of the message to initiate the RACH procedure that occur after reaching a maximum accumulated power ramp.

In a tenth aspect, alone or in combination with one or more of the first through ninth aspects, process 800 includes receiving, from the NES cell, the on-demand SIB1 based on the UL-WUS including the request for the on-demand SIB1.

In an eleventh aspect, alone or in combination with one or more of the first through tenth aspects, the UL-WUS has a format or an identifier to indicate that the UL-WUS includes only the request for the on-demand SIB1.

In a twelfth aspect, alone or in combination with one or more of the first through eleventh aspects, process 800 includes acquiring, from an anchor cell prior to transmitting the UL-WUS, information for selecting or reselecting the NES cell, wherein the on-demand SIB1 includes remaining minimum information to initiate the RACH procedure in the NES cell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 6-7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive an UL-WUS configuration and a RACH configuration for an NES cell, wherein the NES cell is associated with an on-demand SIB1. The transmission component 904 may transmit, to the NES cell, an UL-WUS in an UL-WUS occasion associated with the UL-WUS configuration, wherein the UL-WUS includes one or more of a request for the on-demand SIB1 or a request to start a RACH procedure.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving an UL-WUS configuration and a RACH configuration for an NES cell, wherein the NES cell is associated with an on-demand SIB1; and transmitting, to the NES cell, an UL-WUS in an UL-WUS occasion associated with the UL-WUS configuration, wherein the UL-WUS includes one or more of a request for the on-demand SIB1 or a request to start a RACH procedure.

Aspect 2: The method of Aspect 1, further comprising: transmitting, to the NES cell based on the UL-WUS including the request to start the RACH procedure, a message to initiate the RACH procedure in a RACH occasion associated with the RACH configuration.

Aspect 3: The method of Aspect 2, wherein the UL-WUS has a format or an identifier to indicate that the UL-WUS includes only the request to start the RACH procedure based on acquiring SIB1 associated with the NES cell prior to transmitting the UL-WUS.

Aspect 4: The method of Aspect 2, further comprising: receiving, from the NES cell, the on-demand SIB1 based on the UL-WUS including the request for the on-demand SIB1.

Aspect 5: The method of Aspect 4, wherein the UL-WUS has a format or an identifier to indicate that the UL-WUS includes the request for the on-demand SIB1 and the request to start the RACH procedure.

Aspect 6: The method of Aspect 2, wherein the message to initiate the RACH procedure is transmitted using a transmit power or a number of repetitions that is independent from a transmit power or a number of repetitions used to transmit the UL-WUS.

Aspect 7: The method of Aspect 2, wherein the UL-WUS is transmitted with power ramping over multiple repetitions, and wherein the message to initiate the RACH procedure is transmitted using one or more of a transmit power associated with a last repetition, of the multiple repetitions of the UL-WUS, or with a maximum number of repetitions that is based on a number of the multiple repetitions of the UL-WUS.

Aspect 8: The method of Aspect 7, further comprising: adjusting a power ramping step associated with retransmissions of the message to initiate the RACH procedure to not exceed a maximum accumulated power ramp after the maximum number of repetitions.

Aspect 9: The method of Aspect 7, wherein the maximum number of repetitions is based on a power ramping step, a maximum accumulated power ramp, and the transmit power associated with the last repetition, of the multiple repetitions of the UL-WUS.

Aspect 10: The method of Aspect 7, wherein the transmit power is not increased for one or more repetitions of the message to initiate the RACH procedure that occur after reaching a maximum accumulated power ramp.

Aspect 11: The method of any of Aspects 1-10, further comprising: receiving, from the NES cell, the on-demand SIB1 based on the UL-WUS including the request for the on-demand SIB1.

Aspect 12: The method of Aspect 11, wherein the UL-WUS has a format or an identifier to indicate that the UL-WUS includes only the request for the on-demand SIB1.

Aspect 13: The method of Aspect 11, further comprising: acquiring, from an anchor cell prior to transmitting the UL-WUS, information for selecting or reselecting the NES cell, wherein the on-demand SIB1 includes remaining minimum information to initiate the RACH procedure in the NES cell.

Aspect 14: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-13.

Aspect 15: An apparatus for wireless communication at a device, the apparatus comprising one or more memories and one or more processors coupled to the one or more memories, the one or more processors configured to cause the device to perform the method of one or more of Aspects 1-13.

Aspect 16: An apparatus for wireless communication, the apparatus comprising at least one means for performing the method of one or more of Aspects 1-13.

Aspect 17: A non-transitory computer-readable medium storing code for wireless communication, the code comprising instructions executable by one or more processors to perform the method of one or more of Aspects 1-13.

Aspect 18: A non-transitory computer-readable medium storing a set of instructions for wireless communication, the set of instructions comprising one or more instructions that, when executed by one or more processors of a device, cause the device to perform the method of one or more of Aspects 1-13.

Aspect 19: A device for wireless communication, the device comprising a processing system that includes one or more processors and one or more memories coupled with the one or more processors, the processing system configured to cause the device to perform the method of one or more of Aspects 1-13.

Aspect 20: An apparatus for wireless communication at a device, the apparatus comprising one or more memories and one or more processors coupled to the one or more memories, the one or more processors individually or collectively configured to cause the device to perform the method of one or more of Aspects 1-13.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving an uplink wakeup signal (UL-WUS) configuration and a random access channel (RACH) configuration for a network energy savings (NES) cell, wherein the NES cell is associated with an on-demand system information block 1 (SIB1); and
transmitting, to the NES cell, an UL-WUS in an UL-WUS occasion associated with the UL-WUS configuration, wherein the UL-WUS includes one or more of a request for the on-demand SIB1 or a request to start a RACH procedure.

2. The method of claim 1, further comprising:
transmitting, to the NES cell based on the UL-WUS including the request to start the RACH procedure, a message to initiate the RACH procedure in a RACH occasion associated with the RACH configuration.

3. The method of claim 2, wherein the UL-WUS has a format or an identifier to indicate that the UL-WUS includes only the request to start the RACH procedure based on acquiring SIB1 associated with the NES cell prior to transmitting the UL-WUS.

4. The method of claim 2, further comprising:
receiving, from the NES cell, the on-demand SIB1 based on the UL-WUS including the request for the on-demand SIB1.

5. The method of claim 4, wherein the UL-WUS has a format or an identifier to indicate that the UL-WUS includes the request for the on-demand SIB1 and the request to start the RACH procedure.

6. The method of claim 2, wherein the message to initiate the RACH procedure is transmitted using a transmit power or a number of repetitions that is independent from a transmit power or a number of repetitions used to transmit the UL-WUS.

7. The method of claim 2, wherein the UL-WUS is transmitted with power ramping over multiple repetitions, and wherein the message to initiate the RACH procedure is transmitted using one or more of a transmit power associated with a last repetition, of the multiple repetitions of the UL-WUS, or with a maximum number of repetitions that is based on a number of the multiple repetitions of the UL-WUS.

8. The method of claim 7, further comprising:
adjusting a power ramping step associated with retransmissions of the message to initiate the RACH procedure to not exceed a maximum accumulated power ramp after the maximum number of repetitions.

9. The method of claim 7, wherein the maximum number of repetitions is based on a power ramping step, a maximum accumulated power ramp, and the transmit power associated with the last repetition, of the multiple repetitions of the UL-WUS.

10. The method of claim 7, wherein the transmit power is not increased for one or more repetitions of the message to initiate the RACH procedure that occur after reaching a maximum accumulated power ramp.

11. The method of claim 1, further comprising:
receiving, from the NES cell, the on-demand SIB1 based on the UL-WUS including the request for the on-demand SIB1.

12. The method of claim 11, wherein the UL-WUS has a format or an identifier to indicate that the UL-WUS includes only the request for the on-demand SIB1.

13. The method of claim 11, further comprising:
acquiring, from an anchor cell prior to transmitting the UL-WUS, information for selecting or reselecting the NES cell, wherein the on-demand SIB1 includes remaining minimum information to initiate the RACH procedure in the NES cell.

14. A user equipment (UE) for wireless communication, comprising:
one or more memories; and
one or more processors, coupled to the one or more memories, configured to cause the UE to:
receive an uplink wakeup signal (UL-WUS) configuration and a random access channel (RACH) configuration for a network energy savings (NES) cell, wherein the NES cell is associated with an on-demand system information block 1 (SIB1); and
transmit, to the NES cell, an UL-WUS in an UL-WUS occasion associated with the UL-WUS configuration, wherein the UL-WUS includes one or more of a request for the on-demand SIB1 or a request to start a RACH procedure.

15. The UE of claim 14, wherein the one or more processors are further configured to cause the UE to:
transmit, to the NES cell based on the UL-WUS including the request to start the RACH procedure, a message to initiate the RACH procedure in a RACH occasion associated with the RACH configuration.

16. The UE of claim 15, wherein the UL-WUS has a format or an identifier to indicate that the UL-WUS includes only the request to start the RACH procedure based on acquiring SIB1 associated with the NES cell prior to transmitting the UL-WUS.

17. The UE of claim 15, wherein the one or more processors are further configured to cause the UE to:
receive, from the NES cell, the on-demand SIB1 based on the UL-WUS including the request for the on-demand SIB1.

18. The UE of claim 17, wherein the UL-WUS has a format or an identifier to indicate that the UL-WUS includes the request for the on-demand SIB1 and the request to start the RACH procedure.

19. The UE of claim 14, wherein the one or more processors are further configured to cause the UE to:
acquire, from an anchor cell prior to transmitting the UL-WUS, information for selecting or reselecting the NES cell; and
receive, from the NES cell, the on-demand SIB1 based on the UL-WUS including the request for the on-demand SIB1, wherein the on-demand SIB1 includes remaining minimum information to initiate the RACH procedure in the NES cell.

20. An apparatus for wireless communication, comprising:
means for receiving an uplink wakeup signal (UL-WUS) configuration and a random access channel (RACH) configuration for a network energy savings (NES) cell, wherein the NES cell is associated with an on-demand system information block 1 (SIB1); and
means for transmitting, to the NES cell, an UL-WUS in an UL-WUS occasion associated with the UL-WUS configuration, wherein the UL-WUS includes one or more of a request for the on-demand SIB1 or a request to start a RACH procedure.
